(19) United States
(12) Patent Application Publication
(10) Pub. No.: US 2024/0287239 A1
(43) Pub. Date: Aug. 29, 2024

(54) TWO-PACK TYPE URETHANE MOLDING MATERIAL FOR OPTICAL LENS AND POLYURETHANE RESIN OPTICAL LENS

(71) Applicant: TALEX CO., LTD., Osaka (JP)

(72) Inventors: Hiroo TAMURA, Osaka (JP); Kenzo WADA, Osaka (JP)

(73) Assignee: TALEX CO., LTD., Osaka (JP)

(21) Appl. No.: 18/567,575

(22) PCT Filed: Mar. 14, 2022
(86) PCT No.: PCT/JP2022/011279

§ 371 Date: Dec. 6, 2023

(30) Foreign Application Priority Data
Jun. 7, 2021 (JP) 2021-095204

(51) Int. Cl. C08G 18/18; C08G 18/10; C08G 18/32; C08G 18/48; C08G 18/66; C08G 18/75; C08G 18/76; G02B 1/04; G02C 7/12

(52) U.S. Cl. CPC C08G 18/1883; C08G 18/10; C08G 18/1816; C08G 18/3206; C08G 18/4854; C08G 18/6677; C08G 18/758; C08G 18/7671; G02B 1/041; G02C 7/12

(57) ABSTRACT

Provided is a two-pack type urethane molding material for optical lenses including a main agent containing an isocyanate-terminated prepolymer which is an intermediate product of a polyurethane production reaction by an alicyclic diisocyanate and a polyhydroxy compound; and a curing agent containing an aromatic diamine of dimethylthiotoluenediamine (DMTDA), diethyltoluenediamine (DETDA) or a mixture of these. Also, a polyurethane resin optical lens is provided which is constituted by a cast molded body using the two-pack type urethane molding material.

### TECHNICAL FIELD

The present invention relates to a two-pack type urethane molding material for optical lenses which is a molding material of an optical lens such as a polarizing lens, a polyurethane resin optical lens which is a molded body thereof, and a method for manufacturing a polyurethane resin optical lens.

### BACKGROUND ART

In general, there is known a two-component mixed polyurethane resin molding material for optical lenses in which a polyurethane elastomer is used as a molding material for optical lenses, and a main agent mainly composed of an isocyanate-terminated prepolymer obtained by reacting an alicyclic diisocyanate with a polyol and a curing agent mainly composed of an aromatic polyamine are mixed and reacted (the below-identified Patent Document 1).

The aromatic polyamine as the curing agent described above is composed of 4,4′-methylenebis(2-chloroaniline) [or 3,3′-dichloro-4,4′-diaminodiphenylmethane], and an aromatic polyamine abbreviated as MOCA is well known.

However, in the case of manufacturing a polyurethane resin optical lens using MOCA as a curing agent, there is a case where the optical lens turns yellow after heating during molding, and thus there is room for improving the curing agent.

That is, since the polyurethane resin molding material composition for optical lenses containing MOCA as a curing agent exhibits light yellow at the time of melting, and is likely to change to brown with time thereafter, it has been difficult to stabilize transparency and color tone of the manufactured optical lens with time.

In particular, in an optical lens having a high transmittance or an optical lens having a vivid color tone, discoloration of MOCA is easily noticeable, whereby the transmittance of the optical lens is also reduced, and the vividness of the original color tone is also reduced.

In order to perform color correction (bluing) in anticipation of such a degree of discoloration over time, it requires advanced knowledge and experience regarding dyeing that an appropriate dye for color correction for the material (prepolymer) before molding and curing is selected in advance and an appropriate amount of the dye is added. Therefore, when such color correction work is required, the production efficiency decreases.

Regarding an improvement point of polyurethane for optical lenses, a technique is known in which 4,4′-methylenebis(2-chloroaniline) refined to a Gardner color scale of 2 or less is used as a curing agent for optical lenses for which light-colored or colorless transparency is required, and an antioxidant is further blended to suppress yellowing (the curing agent is also referred to as white moca) (the below-identified Patent Document 2).

The curing agent (MOCA) is a chlorine-containing compound and is also a carcinogenic compound, but does not remain in a product if a curing reaction is completely performed by blending the curing agent in an amount necessary and sufficient for the molecular chain extension reaction. However, since it is necessary not to cause health impairment in terms of occupational safety and health during the process of manufacturing a polyurethane resin product, for example, when it is necessary to cause a large amount of polyurethane resin to undergo a curing reaction at a time in the atmosphere, measures for ensuring safety during the operation process are required.

In the technical field other than the optical lens, a two-pack type urethane curing agent as a substitute for MOCA is used in consideration of safety, and for example, diethyltoluenediamine (hereinafter, it may be abbreviated as DETDA) is known as the curing agent.

This curing agent is a two-pack type urethane waterproof material composition containing a main agent containing an isocyanate group-terminated prepolymer composed of tolylene diisocyanate and polyol, which is a waterproof material used for rooftops of buildings and the like, and a curing agent, and it is known that diethyltoluenediamine (hereinafter, it may be abbreviated as DETDA) is blended as the curing agent (the below-identified Patent Document 3).

In addition, as a two-pack type urethane pavement material for paving a road surface of a stadium, a ground, a race track or the like with elasticity, one containing dimethyltoluenediamine (DMTDA) in an amount of 90 mass % or more as a curing agent is known (the below-identified Patent Document 4).

### PRIOR ART DOCUMENTS

### Patent Documents

Patent Document 1: Japanese Unexamined Patent Application Publication No. 2002-187931
Patent Document 2: Japanese Unexamined Patent Application Publication No. 2003-301025
Patent Document 3: Japanese Unexamined Patent Application Publication No. 2015-21021
Patent Document 4: Japanese Patent No. 64422638

### SUMMARY OF THE INVENTION

### Problems to be Solved by the Invention

However, the two-pack type urethane pavement material and waterproof material described in Patent Document 3 or Patent Document 4 are used in applications in which transparency, color tone, and the like are hardly considered, that is, optical characteristics are not required, or the waterproof material and the road pavement material are not materials having a long pot life in a low viscosity state that can be cast and molded since it is not necessary to increase the melt fluidity of the material to the extent that can be cast and molded.

On the other hand, a molding material for optical lenses in which a spectacle lens is a typical example is required to have a long pot life in a low viscosity state that can be cast and molded, and in addition, there is a case where a dye for adjusting transmittance in a specific wavelength region is added for the purpose of increasing a visible light region, an infrared region or an ultraviolet region other than the visible light region, or contrast, and in a case where polarization needs to be imparted, addition of a required dye or combination with a film or the like containing such a dye is also required, and it is necessary to minimize thermal denaturation of the dye as much as possible, and it is also required to have melt fluidity at a low temperature so that molding can be performed at a low temperature as much as possible.

Therefore, it is an object of the present invention to provide a two-pack type urethane molding material for optical lenses which can be cast molded at a temperature which is as low as possible such that the optical lens molding material which contains a polyurethane resin as a main component and which can be cast molded does not show yellow or brown due to thermal deterioration of the curing agent and a pigment added to the optical lens does not undergo thermal denaturation; and also to provide a two-pack type urethane molding material for optical lenses with which it is possible to manufacture an optical lens which has stable quality and of which the transparency and color tone does not change even after the molding material is subjected to each treatment of mixing, molding, and curing, even as a lens having polarizability due to a polarizing membrane, a lens that has high transmittance and is susceptible to coloring, or a lens having a vivid color tone.

It is also an object of the present invention to create a polyurethane resin optical lens comprising a cast molded body which has stable quality and of which the color tone and transparency do not change over time, by using such a two-pack type urethane molding material for optical lenses; and to efficiently manufacture a polyurethane resin optical lens having good quality as described above.

### Means for Solving the Problems

In order to achieve the above object, the present invention provides a two-pack type urethane molding material for an optical lens, the two-pack type urethane molding material comprising: a main agent containing an isocyanate-terminated prepolymer which is an intermediate product of a polyurethane production reaction by an alicyclic diisocyanate and a polyhydroxy compound; and a curing agent containing an aromatic diamine which is a liquid at normal temperature, wherein the aromatic diamine is dimethylthiotoluenediamine (DMTDA), diethyltoluenediamine (DETDA) or a mixture of these.

In the two-pack type urethane molding material of the present invention, since the isocyanate-terminated prepolymer as the main agent is an intermediate product of a polyurethane production reaction by an alicyclic diisocyanate and a polyhydroxy compound and the curing agent is a predetermined aromatic diamine which is a liquid at normal temperature, these can be uniformly mixed together with a small viscosity difference under mixing conditions of a relatively low temperature of 100° C. or lower. Therefore, addition efficiency of the curing agent is good and a curing reaction can be uniformly performed, foreign matter containing an unreacted curing agent is not generated, and a polyurethane resin optical lens comprising a cast molded body can stably maintain a state of high transparency with time.

Also, by using the predetermined main agent and curing agent, it is possible to obtain a pot life required for cast molding an optical lens, and to improve workability of cast molding a lens. Also, it is possible to obtain a polarizing lens including a polarizing membrane, a lens that is susceptible to coloring and has high transmittance, or a lens having a vivid color tone, as a high-quality optical lens having a stable color tone with time.

The blending ratio of the curing agent is preferably 4 to 37 parts by mass with respect to 100 parts by mass of the main agent so that a lens in which light-colored or colorless transparency is required can be molded with good workability and at a pot life of a required length.

If the curing agent contains a mixture of 15 to 25 parts by mass of dimethylthiotoluenediamine and 1 to 10 parts by of mass diethyltoluenediamine with respect to 100 parts by mass of the isocyanate-terminated prepolymer contained in the main agent, it is possible to easily adjust the pot life required for cast molding By decreasing/shortening the curing time as much as possible, it is possible to further reduce thermal deterioration of a pigment component appropriately blended, stably improve performance and quality due to color tone and pigment, and improve production efficiency.

The optical lens which remarkably shows the above action and effect is preferably a polarizing lens integrally provided with a polarizing membrane. Also, the polarizing lens is preferably a spectacle lens having a high transmittance of 30 to 90% in a visible light region.

By using the above two-pack type urethane molding material for optical lenses, it is possible to obtain a polyurethane resin optical lens comprising a cast molded body having stable quality without changing in color tone over time.

In order to efficiently manufacture an optical lens showing the above action and effect, for example, a method can be used in which an alicyclic diisocyanate composed of 4,4′-methylene-bis(cyclohexyl isocyanate) or isophorone diisocyanate, and a polyhydroxy compound are blended together such that the reaction molar ratio (NCO/OH) thereof is 2.5 to 4.0, an isocyanate-terminated prepolymer which is an intermediate product having an NCO content of 7.0 to 14.0% obtained by a polyurethane production reaction due to this blending is blended with an aromatic polyamine composed of dimethylthiotoluenediamine, diethyltoluenediamine, or both of them at a reaction molar ratio (NCO/NH₂)=1.10 to 0.90, and a liquid mixture of this blending is cast molded.

### Effects of the Invention

The present invention has an advantage in that since the two-pack type urethane molding material comprises a main agent containing an isocyanate-terminated prepolymer which is an intermediate product of a polyurethane production reaction by an alicyclic diisocyanate and a polyhydroxy compound; and a curing agent containing an aromatic diamine which is a liquid at normal temperature composed of dimethylthiotoluenediamine, diethyltoluenediamine or both of them, the optical urethane lens has no yellow or brown coloration due to thermal deterioration of the curing agent, and has high transparency and is stable even after molding and curing.

Also, the present invention has an advantage in that since the two-pack type urethane molding material for optical lenses of the present invention can be cast molded at a temperature which is as low as possible, even when the two-pack type urethane molding material is molded into a polarizing lens including a polarizing membrane, a lens that is susceptible to coloring and has high transmittance, or a lens having a vivid color tone, it is possible to obtain an optical lens which has stable quality and of which the transparency and color tone do not change even after each treatment of mixing, molding, and curing.

Also, the present invention has an advantage in that by cast molding the two-pack type urethane molding material for optical lenses of the present invention, it is possible to efficiently manufacture an optical urethane lens having the above advantages.

### BRIEF DESCRIPTION OF THE DRAWINGS

FIG. 1 is a chart showing the spectral transmittances of spectacle transparent lenses A of Examples 1 to 4.

FIG. 2 is a chart showing the spectral transmittances of spectacle transparent lenses A of Comparative Examples 1 to 3.

FIG. 3 is a chart showing the spectral transmittances of spectacle lenses B of Examples 1 to 4.

FIG. 4 is a chart showing the spectral transmittances of spectacle lenses B of Comparative Examples 1 to 3.

FIG. 5 is a chart showing the spectral transmittances of spectacle lenses C of Examples 1 and 3 and Comparative Example 3.

### BEST MODE FOR CARRYING OUT THE INVENTION

A two-pack type urethane molding material for optical lenses according to an embodiment of the present invention comprises a main agent containing an isocyanate-terminated prepolymer which is an intermediate product of a polyurethane production reaction by an alicyclic diisocyanate and a polyhydroxy compound; and a curing agent containing an aromatic diamine which is dimethylthiotoluenediamine, diethyltoluenediamine or a mixture of these, and which is a liquid at normal temperature.

Typical examples of a polyurethane resin optical lens comprising a cast molded body of the two-pack type urethane molding material include spectacle lenses such as transparent lenses, sunglass lenses, and polarizing lenses.

The alicyclic diisocyanate used in the present invention preferably comprises one or more aliphatic cyclic polyisocyanates selected from the group consisting of 4,4′-methylene-bis(cyclohexyl isocyanate) or isophorone diisocyanate, 2,5(6)-diisocyanate methyl-bicyclo[2,2,1]heptane, and bis(isocyanate methyl)cyclohexane.

Diisocyanates other than those exemplified above make it difficult to obtain desired preferable characteristics in the present invention. For example, if hexamethylene diisocyanate, trimethylhexamethylene diisocyanate, hydrogenated XD1, norbornane diisocyanate or the like is used, it is difficult to sufficiently prolong the pot life of the urethane resin obtained.

The polyhydroxy compound used in the present invention is one of a polyether diol and, a polyester diol that have an average molecular weight of 700 to 1200, and a mixture thereof.

As the polyether diol, polyoxytetramethylene glycol obtained by ring-opening polymerization of tetrahydrofuran or other polyether diols can be used. As the polyester diol, various known polyesters can also be used, and 1,4-butanediol adipate and 1,6-hexanediol adipate is preferable.

For the viscosity of the prepolymer obtained by reacting the polyhydroxy compound with diisocyanate, the prepolymer in which the polyhydroxy compound is a polyether diol is lower in viscosity, and thus is advantageous for casting work. Therefore, the polyhydroxy compound used in the present invention is particularly preferably a polyether diol.

In order to improve the hardness and chemical resistance, an aliphatic polyol having a molecular weight of 300 or less may be used in combination. Examples of the aliphatic polyol include diols such as ethylene glycol, diethylene glycol, propylene glycol, and 1,4-butanediol, and triols such as trimethylolethane and trimethylolpropane.

In the case of producing a prepolymer obtained by reacting a polyisocyanate with a polyhydroxy compound in the present invention, the reaction molar ratio (NCO/OH) is 2.5 to 4.0, and the NCO content of the prepolymer obtained is 7.0 to 14.0%. If the reaction molar ratio and the NCO content are less than the above ranges, the prepolymer viscosity is too high, the casting work is difficult, and the hardness also decreases. If they are larger than the above ranges, the curing properties deteriorate, which is not preferable.

Among the aromatic diamines usable in the present invention, dimethylthiotoluenediamine (DMTDA) is a liquid shown by Chemical Formula 1 below, and having a melting point of 4° C. and a low viscosity at normal temperature (690 cps at 20° C.), and may be an isomer mixture containing 3,5-dimethylthio-2,4-toluenediamine (2,4 isomer) and 3,5-dimethylthio-2,6-toluenediamine (2,6 isomer).

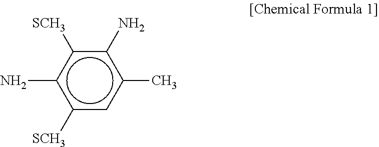

In some cases, commercially available DMTDA (chain extender for curing liquid diamine) contains 4% or less of methylthiotoluenediamine and 1% or less of trimethylthiotoluenediamine together with 95% or more of DMTDA. As a commercially available product of such DMTDA, “ETHACURE 300” commercially available from Mitsui Fine Chemicals, Inc. or the like can be used.

Among the aromatic diamines containable in the curing agent used in the present invention, diethyltoluenediamine (DETDA) is a well-known chemical substance as a chain extender of polyurethane elastomer, and has a chemical in structure which the methylthio group of dimethylthiotoluenediamine (DMTDA) shown in Chemical Formula 1 is substituted with an ethyl group. Examples of a commercially available chain extender for polyurethane containing this substance as a main component include ETHACURE 100 Plus commercially available from Albemarle Corporation or the like.

In the present invention, DETDA or DMTDA can be used alone as a curing agent, but it is preferable to use an aromatic diamine obtained by mixing both of them together in order to facilitate adjustment of the pot life.

The blending ratio of such a curing agent is preferably 4 to 37 parts by mass with respect to 100 parts by mass of the isocyanate-terminated prepolymer so that a lens can be molded while ensuring a pot life which improves workability as described above. The blending ratio of the curing agent is more preferably 5 to 30 parts by mass, and further preferably 10 to 25 parts by mass.

If an aromatic diamine is used in which 15 to 25 parts by mass of DMTDA and 1 to 10 parts by mass of DETDA are mixed together with respect to 100 parts by mass of the main agent, by adjusting the mixing ratio within the above numerical ranges, it is possible to adjust the time of the pot life and the color tone.

Since DETDA is higher than DMTDA in reactivity to the isocyanate-terminated prepolymer, the more DETDA is blended, the shorter the pot life is, and the productivity can be improved by moderately decreasing/shortening the curing time.

As described above, if the blending ratio of DETDA exceeds 10 parts by mass, i.e., the amount of DETDA blended is large, the pot life is short and the workability considerably deteriorates, which is not preferable. For this reason, the blending ratio of DETDA is more preferably 1 to 7 parts by mass, and further preferably 4 to 6 parts by mass, and the optimum blending ratio is considered to be 5 parts by mass.

Also, if DETDA is blended by only 10% or less of DMTDA and other amines, the color tone is improved.

The mixing molar ratio (NCO/NH₂) of the prepolymer to the aromatic polyamine in the present invention is 1.10 to 0.90.

Known treatment conditions or treatment conditions lower in temperature than the known treatment conditions are usable as treatment conditions when conducting cast molding by mixing and heating, and subsequent curing. That is, since the predetermined curing agent used in the present invention is a liquid at normal temperature, the mixture can be treated under mixing conditions of a relatively low temperature of 100° C. or lower, uniformly mixed with a small viscosity difference, and further used for cast molding.

In order to manufacture an impact-resistant optical lens used as a transparent lens such as a spectacle lens, a sunglass lens, a polarizing lens, or the like by casting the polyurethane resin material composition for casting, a known casting method is usable.

That is, in the casting method, a mold member comprising a concave mold and a convex mold liquid-tightly fitted to each other via a gasket is used to mold a lens, and a monomer is injected into a cavity of the mold member, and polymerized and cured.

Especially in the case of manufacturing a polarizing optical lens, when the concave mold and the convex mold are fitted to each other via the gasket having a ring shape, a polarizing element (polarizing film) is placed in advance in the gasket. Then, insert molding is conducted, i.e., a monomer of a resin raw material is injected through an injection hole formed in the mold member or the gasket such that both surfaces of the polarizing element are covered with the resin, and the monomer is polymerized and cured

### EXAMPLES

### Examples 1 to 4

### Production of Prepolymer

In each of Examples 1 to 4, 200 parts by mass of polytetramethylene ether glycol (PTG 1000 made by Hodogaya Chemical Co., Ltd., average molecular weight (MW) 1000) as a polyol component, and 4 parts by mass of trimethylolpropane (TMP) as a polyol component were blended together, the temperature was raised while stirring the mixture in a nitrogen stream, and the mixture was dehydrated at 100° C. under a reduced pressure of 5 to 10 mmHg for 1 hour. After the dehydration, the mixture was cooled, and at 80° C., 224 parts by mass of 4,4′-methylenebiscyclohexyl isocyanate (Desmodur W made by Sumitomo Bayer Urethane Co., Ltd.) was added thereto as an isocyanate component H₁₂MDI, and the mixture was reacted at 100 to 110° C. for 8 hours to produce an isocyanate-terminated prepolymer. The reaction molar ratio (NCO/OH) at this time was 3.5.

<Manufacture of Transparent Lens A> (Mixing with Curing Agent and Cast Molding)

The thus-produced prepolymer was degassed under reduced pressure at 80° C., and then dimethylthiotoluenediamine [DMTDA(1), DMTDA(2)], diethyltoluenediamine (DETDA) or both of them as a curing agent was blended therewith at the blending ratio (parts by mass) shown in Table 1 with respect to 100 parts by mass of the prepolymer.

The two-pack type urethane molding materials of Examples 1 to 4 were each mixed for 1 minute with a mixing defoaming machine, then heated to 96 to 100° C., injected into a glass mold preheated in advance, cast molded, and cured at 95 to 100° C. for 20 hours. The reaction molar ratio (NCO/NH₂) at this time was 1.0. Then, after cured, the material was cooled, and the transparent lens A for spectacles molded was released/removed from the mold.

### Manufacture of Polarizing Lens B

In each of Examples 1 to 4, a polarizing lens B (i) which has a grayish color tone which is less likely to generate a color error, and (ii) with which it is possible to reliably distinguish the color of an object as seen with the naked eye without recognizing the color by mistake was manufactured in the same manner as described above, except that in the mixing with the curing agent and the cast molding step described above, a gasket in which a polarizing membrane is placed at the center was sandwiched between two glass molds, and the mixture for casting comprising the two-pack type urethane molding material was injected between the polarizing membrane and the glass molds.

The above polarizing membrane was formed as follows: A polyvinyl alcohol film having a thickness of 75 μm was uniaxially stretched 4 times, and then was immersed in an aqueous solution (dye solution) containing 0.1 wt % of iodine, 0.04 wt % of Direct Fast Orange and 0.02 wt % of Serious Scarlet B as direct dyes, 0.01 wt % of Sumikaron Yellow RS and 0.012 wt % of Diamira Red B as reactive dyes. Then, the film was immersed in an aqueous solution containing 3 wt % of boric acid, and was subjected to liquid draining. Then, the film was subjected to heat treatment at 70° C. for 5 minutes to manufacture a polarizing film having a thickness of 30 μm. This polarizing film was pressed against a spherical glass to form a spherical surface, and a urethane-based adhesive was applied to both surface portions of the spherical surface and dried. This was placed at the center of the gasket as described above.

### <Manufacture of Polarizing Lens C>

In each of Examples 1 to 4, a polarizing lens C was manufactured in the same manner as in the process of manufacturing the polarizing lens B, except that the dyeing solution for the polarizing membrane was changed to increase the transmittance to 72% or more in a grayish color tone, thereby manufacturing a polarizing spectacle lens that can be used when driving a car at night.

### Comparative Example 1

Except that 37 parts by mass of 4,4′-methylenebis(2-chloroaniline) [MOCA (colorless crystal, melting point: 110° C.), also referred to as white moca] was used as a curing agent instead of dimethylthiotoluenediamine [DMTDA(1), DMTDA(2)] or diethyltoluenediamine (DETDA), and a curing reaction was performed at 120° C., a mixture for molding comprising a two-pack type urethane molding material was prepared in the same manner as in Example 1, and a transparent lens A for spectacles, a polarizing lens B, and a polarizing lens C were manufactured using the mixture.

### Comparative Example 2

Except that 40 parts by mass of 3,3′-dichloro-4,4′-diaminodiphenylmethane [MBOCA] (Cuamine (registered trademark) MT, melting point: higher than 98° C.) was used as a curing agent instead of dimethylthiotoluenediamine [DMTDA(1), DMTDA(2)] diethyltoluenediamine (DETDA), and the mixture was heated to 100 to 110° C. equal to or higher than the melting point, and mixed and cured, a mixture for molding comprising a two-pack type urethane molding material was prepared in the same manner as in Example 1, and a transparent lens A for spectacles, a polarizing lens B, and a polarizing lens C were manufactured using the mixture.

### Comparative Example 3

Except that 37 parts by mass of trimethylenebis(4-aminobenzoate) (CUA-4) was used as a curing agent instead of dimethylthiotoluenediamine [DMTDA(1), DMTDA (2)] or diethyltoluenediamine (DETDA), a mixture for molding comprising a two-pack type urethane molding material was prepared in the same manner as in Example 1, and a transparent lens A for spectacles, a polarizing lens B, and a polarizing lens C were manufactured using the mixture.

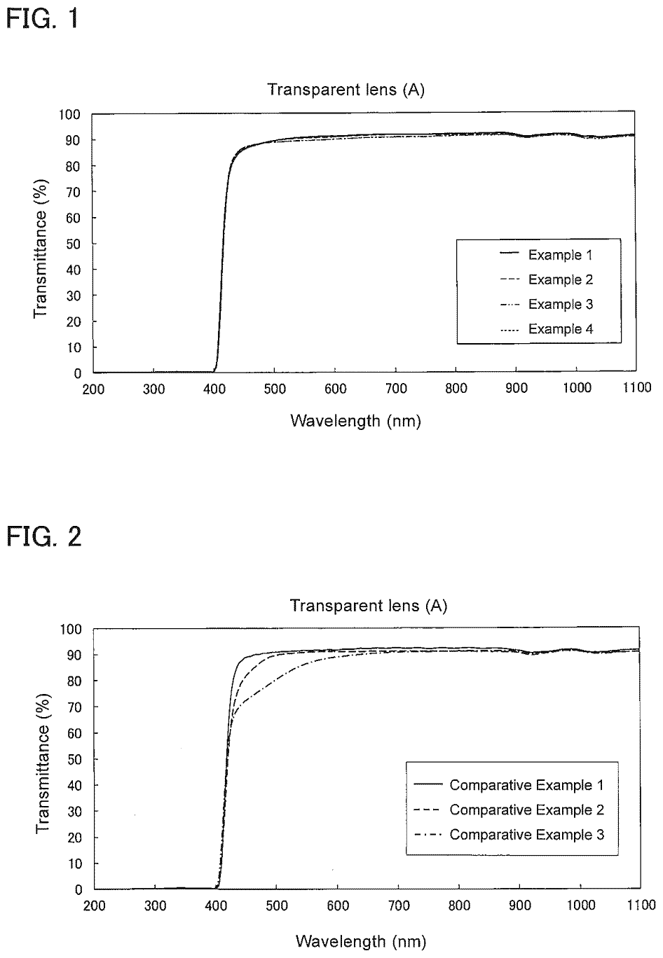

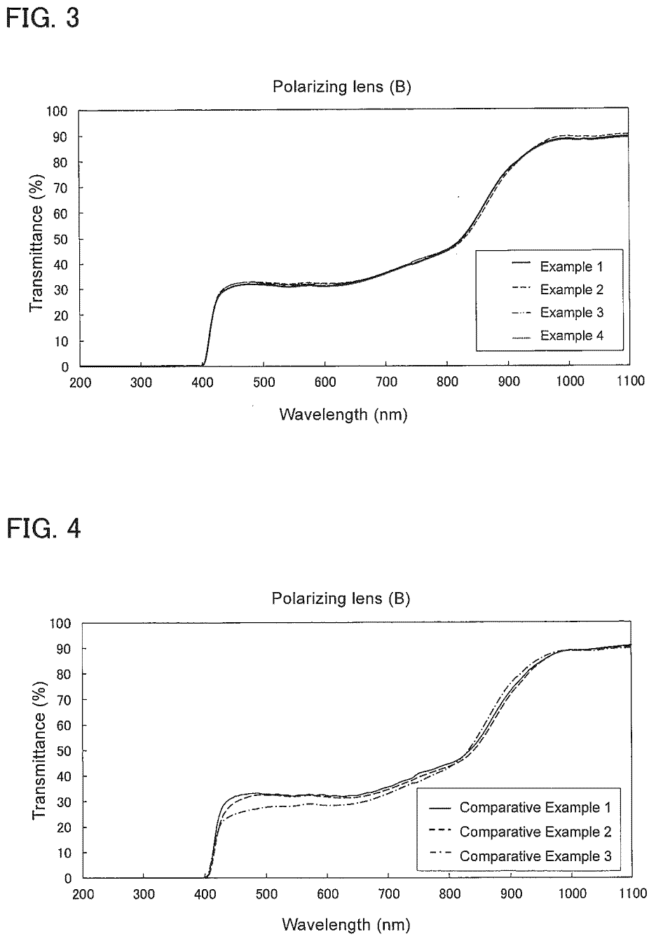

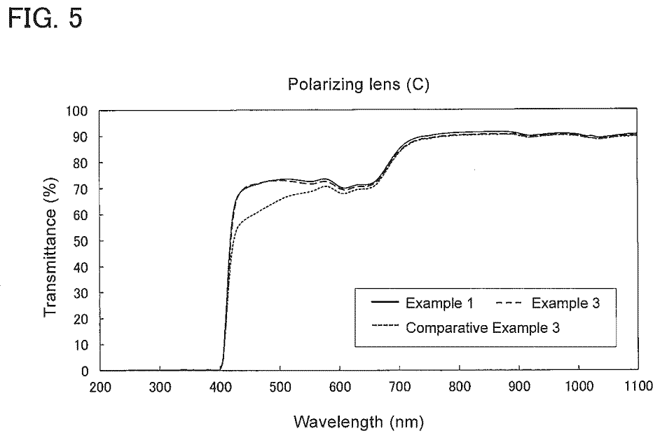

For the obtained transparent lens A for spectacles and polarizing lenses B and C according to each of the Examples and the Comparative Examples, the color coordinate values L, a and b in the UCS color space were measured by an apparatus comprising the combination of 290 color measuring system and Z-II optical sensor made by Nippon Denshoku Industries Co., Ltd. Also, the spectral transmittances in a wavelength range covering 410 to 750 nm were measured by U-2000 Spectrophotometer made by Hitachi Ltd. These results are shown in Table 1 and FIGS. 1 to 5.

Incidentally, as the color coordinate values a and b of a lens approaches 0, a gray color is shown which is less likely to generate color false recognition when the lens is used as a spectacle optical lens. Also, the value a shows a stronger red color on the positive side thereof, and shows a stronger green color on the negative side thereof. Also, the value b shows a stronger yellow color on the positive side thereof, and shows a stronger blue color on the negative side thereof.

TABLE 1

| | | | Examples - Comparative Examples | | | | | | |
|---|---|---|---|---|---|---|---|---|---|
| | | | Examples | | | | Comparative Examples | | |
| Formulation (parts by mass) - Lens name | | | 1 | 2 | 3 | 4 | 1 | 2 | 3 |
| Main agent | Isocyanate-terminated prepolymer | | 100 | 100 | 100 | 100 | 100 | 100 | 100 |
| Curing | DMTDA (1) | | 20 | — | — | 18 | — | — | — |
| agent | DMTDA (2) | | — | 30 | — | — | — | — | — |
| | DETDA | | — | — | 7 | 5 | — | — | — |
| | MOCA | | — | — | — | — | 37 | — | — |
| | MOCA-like MT | | — | — | — | — | — | 40 | — |
| | MOCA-like CUA-4 | | — | — | — | — | — | — | 37 |
| Transparent | Transparency | Transmittance | 90.44 | 90.14 | 92.21 | 90.00 | 91.28 | 90.15 | 85.86 |
| lens A | | Value Y | 89.53 | 89.91 | 90.56 | 89.59 | 90.28 | 89.88 | 84.95 |
| | Color tone | Value a | −1.48 | −1.75 | −0.56 | −1.23 | −1.58 | −3.38 | −1.63 |
| | | Value b | 5.13 | 4.7 | 2.21 | 3.98 | 6.25 | 8.44 | 11.11 |
| Polarizing | Transparency | Transmittance | 31.14 | 31.68 | 33.8 | 31.82 | 32.27 | 32.05 | 28.37 |
| lens B | | Value Y | 30.86 | 30.92 | 31.37 | 31.00 | 30.56 | 30.68 | 27.75 |
| | Color tone | Value a | 0.17 | −0.42 | 0.02 | 0.07 | −0.43 | −1.78 | −1.08 |
| | | Value b | 1.80 | 1.5 | 1.04 | 1.18 | 2.95 | 3.64 | 4.91 |
| Polarizing | Transparency | Transmittance | 72.62 | — | 73.18 | 71.91 | 69.24 | — | 68 |
| lens C | | Value Y | 72.55 | — | 72.97 | 71.8 | 70.19 | — | 67.67 |
| | Color tone | Value a | −1.58 | — | −1.25 | −1.52 | 0 | — | −1.72 |
| | | Value b | 2.9 | — | 1.68 | 2.47 | 5.67 | — | 8.33 |

As is apparent from the results shown in FIGS. 1 to 5, the transmittances in the visible light region of the transparent lenses A and the polarizing lenses B formed of the molding materials of Examples 1 to 4 were similar to the transmittances of the lenses formed of the molding material of Comparative Example 1, in which MOCA was as a curing agent.

The transmittances in the visible light region of the transparent lenses A and the polarizing lenses B and C formed of the molding materials of Examples 1 to 4 were higher than those in Comparative Example 2 or Comparative Example 3, and, particularly in the short wavelength region of 400 to 600 nm, the transmittances of the lenses of Examples 1 to 4 were considerably higher than those in Comparative Example 2, 3.

As for the color tones (color coordinate values a, b) of the lenses shown in Table 1, the color coordinate values b of the transparent lens A and the polarizing lenses B and C obtained from the molding material of Comparative Example 1 showed yellowish colors of 6.25, 2.95 and 5.67, respectively,

However, for the lenses A, B and C using the molding material of each of Examples 1 to 4, the values b were lower than the above respective values b, and yellowing was suppressed.

MOCA (white moca) used in the molding material of Comparative Example 1 needs to be heated to 120° C. or more during molding, and tends to thermally deteriorate to generate brown foreign matter when heated for a required time or longer at a dead point remaining during heating.

Also, for each of the transparent lens A and the polarizing lens B formed of the molding material of Comparative Example 2, the values a and b were higher than the corresponding respective coordinate values of Comparative Example 1, and it was difficult to adjust these coordinate values to values close to 0 to obtain a desired gray color. Since MOCA-like MT [MBOCA: Cuamine (registered trademark) MT] used as a curing agent in the molding material of Comparative Example 2 contains, as a main component, a chemical compound including a chlorine atom, a safe working environment cannot be ensured.

In the color tone of the transparent lens A of Comparative Example 3, in which MOCA-like CUA-4 [trimethylenebis(4-aminobenzoate) (CUA-4)] was used as a curing agent, the value b (11.11) was considerably high, and yellowing was shown.

The color tone recognized in the molding material of Comparative Example 3 was similarly recognized in the gray-based polarizing lens B which is less likely to generate color false recognition, and in the gray-based polarizing lens C having high visible light transmittance. Especially of the polarizing lens C, the value b was remarkably higher than that of the polarizing lens B, and a yellow color appeared considerably strongly.

Also, for the transparent lens A formed of the molding material of Comparative Example 3, it was difficult to release/remove the lens from a glass mold, and it was difficult to improve the production efficiency of the optical lens.

In contrast thereto, for all of the transparent lens A and the polarizing lenses B and C in each of Examples 1 to 4, in which DMTDA, DETDA or a mixture of both is used as a curing agent, it was possible to mix the main agent and the curing agent together at a temperature lower than the temperature in Comparative Example 1, and it was possible to conduct cast molding and curing at a low temperature of 100° C. or lower.

Also, compared to the values b in Examples 1 and 2, in which DMTDA or DETDA was used alone, the values b in Example 4, in which a mixture of DMTDA and DETDA was used, were low, and yellowing was suppressed to be low in all of the lenses. Also, for lenses having substantially the same transmittance, it was felt that transparency is better in the lens having less yellowing.

In each of the transparent lens A, the polarizing lens B, and the polarizing lens C (lens susceptible to coloring and having high transmittance) that are formed of the molding material of each of Examples 1 to 4, both the value a and the value b, which show the color tone, were lower than the value a and the value b in Comparative Example 2, 3. Also, the lenses of Examples 1 to 4 were excellent in production efficiency, because they were released/removed easily from molds.

As described above, for optical lenses formed of the two-pack type urethane molding materials of Examples 1 to 4, even if the lenses are lenses containing a pigment, e.g., transparent or polarizing lenses, the color tones did not change before and after heat treatment, and there was no discoloration of yellow or brown due to thermal deterioration of the curing agents, so that the qualities were stable and excellent.

1. A two-pack type urethane molding material for an optical lens, the two-pack type urethane molding material comprising:
a liquid main agent containing an isocyanate-terminated prepolymer which is an intermediate product of a polyurethane production reaction by an alicyclic diisocyanate and a polyhydroxy compound; and
a curing agent containing an aromatic diamine which is a liquid at normal temperature,
wherein the aromatic diamine is dimethylthiotoluenediamine, diethyltoluenediamine or a mixture of these.

2. The two-pack type urethane molding material according to claim 1, wherein a blending ratio of the curing agent is 4 to 37 parts by mass with respect to 100 parts by mass of the isocyanate-terminated prepolymer.

3. The two-pack type urethane molding material according to claim 2, wherein the curing agent contains a mixture of 15 to 25 parts by mass of dimethylthiotoluenediamine and 1 to 10 parts by mass of diethyltoluenediamine with respect to 100 parts by mass of the isocyanate-terminated prepolymer.

4. The two-pack type urethane molding material according to claim 1, wherein the optical lens is a polarizing optical lens.

5. The two-pack type urethane molding material according to claim 4, wherein the polarizing optical lens is a spectacle lens having a transmittance of 30 to 90% in a visible light region.

6. A polyurethane resin optical lens comprising a cast molded body of the two-pack type urethane molding material according to claim 1.

7. The two-pack type urethane molding material according to claim 2, wherein the optical lens is a polarizing optical lens.

8. The two-pack type urethane molding material according to claim 3, wherein the optical lens is a polarizing optical lens.

9. The two-pack type urethane molding material according to claim 7, wherein the polarizing optical lens is a spectacle lens having a transmittance of 30 to 90% in a visible light region.

10. The two-pack type urethane molding material according to claim 8, wherein the polarizing optical lens is a spectacle lens having a transmittance of 30 to 90% in a visible light region.

11. A polyurethane resin optical lens comprising a cast molded body of the two-pack type urethane molding material according to claim 2.

12. A polyurethane resin optical lens comprising a cast molded body of the two-pack type urethane molding material according to claim 3.

13. A polyurethane resin optical lens comprising a cast molded body of the two-pack type urethane molding material according to claim 4.

14. A polyurethane resin optical lens comprising a cast molded body of the two-pack type urethane molding material according to claim 5.

15. A polyurethane resin optical lens comprising a cast molded body of the two-pack type urethane molding material according to claim 7.

16. A polyurethane resin optical lens comprising a cast molded body of the two-pack type urethane molding material according to claim 8.

17. A polyurethane resin optical lens comprising a cast molded body of the two-pack type urethane molding material according to claim 9.

18. A polyurethane resin optical lens comprising a cast molded body of the two-pack type urethane molding material according to claim 10.
